(19) United States
(12) Patent Application Publication
(10) Pub. No.: US 2017/0190153 A1
(43) Pub. Date: Jul. 6, 2017

(54) FIRE PROTECTION PANE AND FIRE PROTECTION GLAZING

(71) Applicant: Saint-Gobain Glass France, Courbevoie (FR)

(72) Inventors: Udo GELDERIE, Würselen (DE); Norbert SCHWANKHAUS, Baesweiler (DE); David TE STRAKE, Aachen (DE)

(21) Appl. No.: 15/313,262

(22) PCT Filed: May 26, 2015
(86) PCT No.: PCT/EP2015/061552

§ 371 Date: Nov. 22, 2016

(30) Foreign Application Priority Data
May 28, 2014 (EP) 14170271.2

(51) Int. Cl. B32B 17/10; B32B 17/06

(52) U.S. Cl. CPC B32B 17/10311; B32B 17/069; B32B 2307/3065; B32B 2309/105

(57) ABSTRACT

A fire-protection pane, including at least one float glass pane with an atmosphere side and with a tin bath side, at least one protective layer, which is arranged in a surfaced manner on the atmosphere side and/or the tin bath side, and at least one fire-protection layer, which is arranged in a surfaced manner on the protective layer. The protective layer is a multi-layer layer structure and includes a first sub-protective-layer of metal-doped silicon nitride, and a second sub-protective-layer of a tin/zinc oxide or a doped tin/zinc oxide.

### BACKGROUND OF THE INVENTION

Field of the Invention

The invention relates to a fire-protection pane, in particular for fire-protection glazing, with a protective layer for reducing the hazing (clouding) of the pane with ageing. The invention moreover relates to a method for manufacturing such a fire-protection glazing and to its use.

Description of Related Art

Fire-protection glazing is known in different embodiments and is applied, for example, in the field of construction. As a rule, it consists of at least two transparent carrier elements such as two glass panes, between which a fire-protection layer of a transparent, intumescent material is arranged. A fire-protection layer of a hydrous alkali silicate is known, for example, from EP 0 620 781 B1. The water contained in the alkali silicate layer evaporates under the effect of heat upon the fire-protection layer glazing, and the alkali silicate foams. The transparency of the fire-protection layer is then greatly reduced, in particular for thermal radiation, and for a certain while protects against the undesirable transfer of heat. The great expansion of the fire-protection layer as a rule leads to the fragmentation of one of the glass panes and in particular to the fragmentation of the glass pane facing the fire source. Several glass panes with fire-protection layers lying therebetween are therefore arranged one after the other, for improving the heat protection and the mechanical stability.

Further, improved fire-protection layers based on alkali silicate with a particularly high water share of 80% to 90% are known, for example from EP 0 192 249 A2.

A fire-protection pane and fire-protection glazing with such fire-protection layers in the course of time often display punctiform or regional cloudiness in the visible region.

### SUMMARY OF THE INVENTION

It is therefore the object of the present invention, to provide a fire-protection pane that has an improved resistance to ageing and, in particular, a reduced haze during ageing.

A fire-protection pane according to the invention includes
at least one float glass pane with an atmosphere side and with a tin bath side,
at least one protective layer which is arranged in a surfaced manner on the atmosphere side and/or on the tin bath side of the float glass pane and
at least one fire-protection layer which is arranged in a surfaced manner on the protective layer;
   wherein the protective layer is a multi-layer layer structure and includes or consists of a first sub-protective-layer of metal-doped silicon nitride, and a second sub-protective-layer of tin/zinc oxide or doped tin/zinc oxide.

In one advantageous design of the fire-protection pane according to the invention, the protective layer is designed in a two-layer manner.

The fact that the protective layer is arranged in a surfaced manner here means that the float glass pane is arranged essentially on its complete atmosphere side or tin bath side. Here, essentially means that at least 70% and preferably at least 85% and in particular at least 95% of the respective side is covered with the protective layer. The same applies to an arrangement of the fire-protection layer on the protective layer in a surfaced manner. In particular, the protective layer is arranged on the respective side of the float glass pane such that the fire-protection layer is not in direct contact with the float glass pane, but only via the protective layer.

The present invention is based on the recognition, which is to say on the finding of the inventor, that depending on the glass quality, some float glass panes, which with their tin bath side were in contact with the fire-protection layer, displayed a significant hazing of the view through the arrangement of the float glass pane and the fire-protection layer, in the ageing test. In contrast, with float glass panes which with their atmosphere side were arranged in contact with the fire-protection layer, no or only a slight hazing of the through-view manifested itself with the ageing test. Thus, a hazing of the through-view in the ageing test could be avoided or significantly reduced by way of incorporating a protective layer according to the invention, between the tin bath side of the float glass pane and the fire-protection layer.

The invention can be understood by the following model: On manufacture, the tin bath side of the hot float glass pane is in contact with the tin bath. This leads to the formation of a surface which, on contact with a typically alkaline fire-protection layer, can develop an inhomogeneous, strip-like hazing and a hazy appearance after ageing, depending on the morphology of the tin layer. The atmosphere side of the float glass pane, on contact with the alkaline fire-protection layer, only displays a homogeneous hazing, which is only very slight and can hardly be perceived, and leads to no or only a small strip-like hazing. The strip-like hazing of the tin bath side on contact with the alkaline fire-protection layer is reduced and homogenised due to the incorporation of the protective layer according to the invention, so that no or only a slight and hardly perceivable homogeneous hazing is visible, similarly to the atmosphere side.

In one advantageous design of the fire-protection pane according to the invention, the protective layer is only arranged in a surfaced manner on the tin bath side of the float glass pane and not on the atmosphere side.

In one advantageous design of the fire-protection pane according to the invention, the fire-protection layer is alkaline.

The fire-protection layer according to the invention advantageously includes alkali silicate or alkali polysilicate and preferably alkali silicate water glass. Such fire-protection layers are known for example from EP 0 620 781 B1 or EP 1 192 249 A2. Alternative fire-protection layers include alkali phosphate, alkali tungstenate and/or alkali molybdate, as is known from DE 35 30 968 C2.

Further alternative fire-protection layers include a hydrogel with a solid phase of a polymer and preferably of polyacrylamide or N-methylacrylamide, as is known from DE 27 13 849 C2, or polymerised 2-hydroxy-3-methacryloxypropyl trimethyl ammonium chloride, as is known from DE 40 01 677 C1.

The thickness of the fire-protection layers can vary greatly and be adapted to the respective demands of the application purpose. Advantageous fire-protection layers with silicates have a thickness h of 0.5 mm to 7 mm and preferably of 1 mm to 6 mm. The thicknesses lie between 8 mm and 70 mm with hydrogels.

The second sub-protective-layer according to the invention includes at least a tin/zinc oxide or a doped tin/zinc oxide. The tin/zinc oxide or the doped tin/zinc oxide is advantageously non-crystalline. It can preferably be amorphous or partially amorphous (and thus partially crystalline), but is not completely crystalline. Such a non-crystalline, second sub-protective-layer has the particular advantage that it has a low roughness and thus forms an advantageously smooth surface for the layers to be deposited above the second sub-protective-layer, wherein scratches and point defects are filled.

In one advantageous design of the fire-protection pane according to the invention, the second sub-protective-layer includes doping, for example of antimony, fluorine, boron, silver, ruthenium, palladium, aluminium and tantalum. The share of the doping of the metallic share of the protective layer in percentage by weight (% by weight) is preferably 0.01% by weight to 10% by weight, particularly preferably 0.1% by weight to 5% by weight and in particular 0.5% by weight to 2.5% by weight. Fire-protection panes with second sub-protective-layers that have such a doping displayed a particularly low hazing during ageing. Thereby, antinomy-doped tin/zinc oxide layers have been found to be particularly suitable.

In one advantageous design of the fire-protection pane according to the invention, the second sub-protective-layer has a ratio of zinc:tin of 5% by weight:95% by weight to 95% by weight:5% by weight, and preferably of 15% by weight:85% by weight to 70% by weight:30% by weight. Protective layers of tin/zinc oxide or doped tin/zinc oxide with such mixture ratios are particularly durable and display particularly low hazing during ageing.

In one advantageous design of the fire-protection pane according to the invention, the second sub-protective-layer includes SnₓZn_{y}O_{z} or doped SnₓZn_{y}O_{z} with 0<z≦(y+2x) and particularly preferably 0.7*(y+2x)≦z≦(y+2x) and particularly preferably 0.9*(y+2x)≦z≦(y+2x). Fire-protection panes with second sub-protective-layers with such mixing ratios are particularly durable and display particularly low hazing during ageing. In a particularly advantageous design of the fire-protection pane according to the invention, the second sub-protective-layer includes ZnSnO₃, doped ZnSnO₃, Zn₂SnO₄ or doped Zn₂SnO₄ or mixtures thereof. Second sub-protective-layers with such mixture ratios are particularly durable and display particularly low hazing during ageing.

In one advantageous design of the fire-protection pane according to the invention, the second sub-protective-layer consists of tin/zinc oxide as well as, as the case may be, of a dopant metal and admixtures which are inherent of manufacture. Second sub-protective-layers with such mixing ratios are particularly durable and display particularly low hazing during ageing.

The deposition of the tin/zinc mixed oxide takes place, for example, under addition of oxygen as a reaction gas during the cathode sputtering.

In one advantageous design of the second sub-protective-layer according to the invention, the layer thickness d_{b} of the second sub-protective-layer is from 2 nm to 200 nm, preferably 10 nm to 50 nm and particularly preferably from 13 nm to 21 nm. Fire-protection panes with a second sub-protective-layer with these layer thicknesses displayed particularly low hazing during ageing.

The first sub-protective-layer according to the invention includes at least one metal-doped silicon nitride. The doping metal is preferably antimony, silver, ruthenium, palladium, aluminium and/or tantalum. The best results with particularly low hazing during the manufacture in the corrosion test and in the scratch test could be achieved with aluminium-doped silicon nitride layers.

In one advantageous design of the fire-protection pane according to the invention, the share of the doping metal and in particular of the aluminium of the first sub-protective-layer is 1% by weight to 20% by weight and preferably 3% by weight to 7% by weight. Fire-protection layers with such first sub-protective-layers displayed the best resistances or durabilities in the corrosion test and in the scratch test.

In a further advantageous design of the fire-protection pane according to the invention, the layer thickness dₐ of the first sub-protective-layer is 2 nm to 200 nm, preferably 5 nm to 50 nm, particularly preferably from 5 nm to 26 nm and in particular from 8 nm to 13 nm. Fire-protection planes with such first sub-protective-layers displayed the best durabilities and lowest hazing in the corrosion test and in the scratch test.

In one advantageous design of the fire-protection pane according to the invention, the first sub-protective-layer consists of a metal-doped and in particular of an aluminium-doped silicon nitride as well as of admixtures which are inherent of manufacture.

Trials undertaken by the inventor have found that a two-layer protective layer with a sub-protective-layer of a metal-doped silicon nitride has the advantage that the second sub-protective-layer of tin/zinc oxide or doped tin/zinc oxide can be designed more thinly than with a single-layer protective layer of tin/zinc oxide or of doped tin/zinc oxide. Despite this, such two-layer protective layers, however, are particularly resistant with regard to alkaline fire-protection layers and display low hazing during ageing as well a very good durability in the corrosion test and in the scratch test.

A synergetic interaction of a metal-doped silicon nitride layer with the tin/zinc oxide layer or the doped tin/zinc oxide layer even permits the second sub-protective-layer of tin/zinc oxide or doped tin/zinc oxide to be able to be reduced such that the total layer thickness of the two-layer protective layer can be selected lower than with a protective layer of a mono-layer of tin/zinc oxide or doped tin/zinc oxide, with an equally good durability with regard to the fire-protection layer. A reduction of the total layer thickness of the protective layer can lead to an improvement of the optical characteristics of the fire-protection pane, as well as to an increased transparency and a reduced chromatic aberration. Metal-doped silicon nitride layers with regard to process technology are very simple and inexpensive to manufacture, and have a high optical transparency. In particular, metal-doped silicon nitride layers are less expensive to manufacture than tin/zinc oxide layers.

In one advantageous embodiment, the first sub-protective-layer of metal-doped silicon nitride is arranged directly on the tin bath side of the float glass pane, and the second sub-protective-layer of tin/zinc oxide or doped tin/zinc oxide on the first sub-protective-layer. The best results can be achieved with such layer sequences. It is to be understood that the sequence of the materials can however also be exchanged, so that the second sub-protective-layer is arranged directly on the tin bath side of the float glass pane, and the first sub-protective-layer of metal-doped silicon nitride on the second sub-protective-layer.

The float glass pane according to the invention is manufactured with a float method. Such methods are known, for example, from FR 1 378 839 A. With float glass manufacture, a doughy-fluid glass molten mass is continuously led from one side onto an elongate bath of liquid tin in a continuous process. The glass melt floats on the tin bath, and a uniform glass film spreads out. A very smooth glass surface forms due to the surface tensions of the tin and the liquid glass. The glass melt is cooled down and solidified at the rear end of the tin bath. The side of the float glass pane that floats on the tin bath on manufacture is indicated as the tin bath side in the framework of the present application. The side of the float glass pane that lies at the side opposite to the tin bath is indicated as the atmosphere side.

The float glass pane includes or consists preferably of borosilicate glass, alumosilicate glass or alkaline earth silicate glass and particularly preferably of soda-lime glass and in particular soda-lime glass according to the standard EN 572-1:2004.

The float glass pane is advantageously thermally prestressed or part-prestressed. The thermally part-prestressed or prestressed float glass pane preferably has a prestress of 30 MPa to 200 MPa and particularly preferably of 70 MPa to 200 MPa. Such prestressed or part-prestressed float glass panes are known, for example, from DE 197 10 289 C1. Thermally prestressed or part prestressed float glass panes are particularly suitable for fire-protection panes due to their high stability, and the inventive effect of the protective layer is particularly advantageous.

The thickness of the float glass pane can vary widely and thus be excellently adapted to the demands of the individual case. Panes with the standard thicknesses of 1 mm to 25 mm and preferably of 2 mm to 12 mm are preferably used. The size of the pane can vary widely and is directed according to the size of the application according to the invention.

The float glass pane can have any three-dimensional shape. The three-dimensional shape preferably has no shadow zones, so that it can be coated by way of cathode sputtering, for example. The pane is preferably planar or bent in one direction or more directions of space, to a greater or lesser extent. The float glass pane can be colourless or coloured.

The float glass pane according to the invention can consist of a composite of two or more individual float glass panes that are connected to one another in each case via at least one intermediate layer. The intermediate layer preferably includes a thermoplastic plastic, such as polyvinyl butyral (PVB), ethylene vinyl acetate (EVA), polyurethane (PU), polyethylene terephthalate (PET) or several layers thereof, preferably with thicknesses of 0.3 to 0.9 mm.

In one advantageous design of the fire-protection pane according to the invention, at least one bonding (adhesion) enhancement layer or a bonding reduction layer is arranged between the protective layer and the fire-protection layer. The bonding enhancement layer typically includes organically hydrophilic substances based on silanes, titanates or zirconates and is known, for example, from EP 0 001 531 B1 and EP 0 590 978 A1. Bonding reduction layers for example include hydrophobic organo-functional silanes such as fluoralkyl silanes, perfluoralkyl silanes, fluoralkyltrichlor silanes, fluoralkylalkoxy silanes, perfluoralkyl alkoxy silanes, fluoraliphatic silylether, alkyl silanes and phenyl silanes and silicones. Such hydrophobic organo-functional silanes are known, for example, from DE 197 31 416 C1. Alternative bonding reduction layers include polymer waxes, preferably based on polyethylene.

In one advantageous design of the fire-protection pane according to the invention, at least one further layer, which, for example, influences the optical characteristics of the fire-protection pane, is arranged between the tin bath side of the float glass pane and the protective layer. Such a further layer, for example, increases the transmission through the fire-protection pane, reduces reflections or gives the transmitted light colour.

The protective layer is advantageously transparent to electromagnetic radiation, preferably electromagnetic radiation of a wavelength of 300 nm to 1300 nm, and in particular to visible light. “Transparent” means that the total transmission through the float glass pane coated with the protective layer has a transmission of more than 50%, preferably of more than 70% and particularly preferably more than 90%.

The invention moreover includes a fire-protection glazing, which includes at least
a fire-protection pane according to the invention, and
a second float glass pane with an atmosphere side and a tin bath side,
   wherein the second float glass pane via its atmosphere side is connected in a surfaced manner to the fire-protection layer of the fire-protection pane.

An alternative design of a fire-protection glazing according to the invention includes at least
a fire-protection pane according to the invention, and
a second float glass pane with an atmosphere side and a tin bath side,
   wherein the second float glass pane on the tin bath side includes a second protective layer according to the invention, and the second float glass pane is connected in a surfaced manner to the fire-protection layer of the fire-protection pane via the second protective layer.

In an advantageous further development of the fire-protection glazing according to the invention, the atmosphere side of the float glass pane of the fire-protection pane is connected in a surfaced manner to a second fire-protection layer, and the second fire-protection layer is connected in a surfaced manner to the atmosphere side of a third float glass pane.

In an alternative further development of the fire-protection glazing according to the invention, the atmosphere side of the float glass pane of the fire-protection pane is connected in a surfaced manner to a second fire-protection layer, and the second fire-protection layer is connected via a further protective layer to the tin bath side of a third float glass pane.

Such triple glazing has a particularly high stability and fire-protection effect. It is to be understood that fire-protection panes with four or more float glass layers can be manufactured according to a similar principle, wherein a protective layer according to the invention is arranged between each fire-protection layer and the directly adjacently arranged tin bath side of a float glass pane, for the inventive avoidance of the hazing of the through-view on ageing. “Directly adjacently arranged” here means that no glass pane is present between the tin bath side and the fire-protection layer.

The invention moreover includes a fire-protection glazing of a stack sequence of a first float glass pane, a first fire-protection layer, a second float glass pane, a second fire-protection layer and a terminating float glass pane, wherein a protective layer according to the invention is arranged between each tin bath side and a directly adjacently arranged fire-protection layer.

In a further development of this fire-protection glazing according to the invention, at least one further float glass pane and a further fire-protection layer are arranged within the stack sequence. It is to be understood that a further protective layer according to the invention is arranged between each tin bath side of a further float glass pane and a directly adjacently arranged fire-protection layer.

The fire-protection glazing and in particular the outer-lying float glass pane can have additional functional coatings with a UV-reflecting and/or infrared-reflecting effect for the protection of the fire-protection glazing and in particular of the fire-protection layer, from heat and UV-radiation. Moreover, several fire-protection glazings can form an insulation glazing by way of evacuated or gas-filled intermediate spaces.

The invention includes a method for manufacturing a fire-protection glazing, where at least:
a. a protective layer is deposited on the tin bath side of a first float glass pane,
b the first float glass pane and a second float glass plane are held at a fixed distance, so that a mould cavity is formed between the tin bath side of the first float glass plane and the second float glass pane and
c. a fire-protection layer in liquid form is cast into the mould cavity and is cured.

In one advantageous embodiment of the method according to the invention, the method steps are repeated such that a third float glass pane is held at a fixed distance to the first or the second float glass pane, and the mould cavity, which is formed by this, is filled with a second fire-protection layer. This method step can also take place in parallel, which is to say that three or more float glass panes are simultaneously held at a distance and the fire-protection layers are formed by way of simultaneously pouring-in of the aqueous solution of the silicate or the hydrogel. It is to be understood that the method can accordingly be carried out repeatedly for forming multi-pane fire-protection glazing with four or more float glass panes.

The depositing of the protective layer in method step (a) can be effected by way of a method known per se, preferably by way of magnetic-field enhanced cathode sputtering. This is particularly advantageous with regard to a simple, rapid, inexpensive and uniform coating of the float glass pane.

A method for manufacturing tin/zinc mixed oxide layers by way of reactive cathode sputtering is known for example from DE 198 48 751 C1. The tin/zinc mixed oxide is preferably deposited with a target which includes 5% by weight to 95% by weight of zinc, 5% by weight to 95% by weight of tin, and 0% by weight to 10% by weight of antimony, as well as admixtures which are inherent of manufacture. The target in particular includes 15% by weight to 70% by weight of zinc, 30% by weight to 85% by weight of tin and 0% by weight to 5% by weight of antimony as well as admixtures of other metals that are inherent of manufacture. The deposition of the tin/zinc oxide or of the doped tin/zinc oxide is effected, for example, while adding oxygen as a reaction gas during the cathode spluttering.

The metal-doped silicon nitride layers are likewise manufactured, for example, by way of reactive cathode sputtering, in particular by way of the use of a metal-doped silicon target. The deposition of the first sub-protective-layer of metal-doped silicon nitride is then effected, for example, under addition of nitrogen as a reaction gas during the cathode sputtering.

The first and/or the second sub-protective-layer can alternatively be deposited by way of vapour deposition, chemical vapour deposition (CVD), plasma-enhanced chemical vapour deposition (PECVD), by way of sol-gel methods or by way of wet-chemical methods.

In method step (b), the first float glass pane and the second float glass pane are held at a fixed distance, so that a mould cavity forms. This can be effected, for example, by way of spacers, which are preferably arranged in the edge region of the float glass panes. The spacers can thereby remain in the fire-protection glazing as a fixed constituent or be removed again. The float glass panes can alternatively be fixed in position by way of external holders.

The not yet cured, pourable fire-protection layer is cast into the mould cavity in method step (c) and is subsequently cured. In the case of a fire-protection layer of an aqueous alkali silicate, an alkali silicate, for example, is joined together with a curing agent, which contains or releases silicon dioxide. The pourable mass that is formed therefrom is cast into the mould cavity. There, the mass cures into a solid alkali silicate layer amid the retention of the water content. Methods for manufacturing a fire-protection layer of a hydrogel are known, for example, from WO 94/04355 or DE 40 01 677 C1.

In an advantageous further development of the method according to the invention, the first float glass pane and/or the first float glass pane as well as the second float glass pane are thermally prestressed or part-prestressed before the method step (a) or between the method steps (a) and (b).

The invention further includes the use of a protective layer according to the invention, between the tin bath side of a float glass pane and a fire-protection layer, in particular of an alkaline fire-protection layer, for reducing the haze of the float glass pane on ageing.

The invention moreover includes the use of a fire-protection pane as a construction element, as a room divider, as part of an outer facade or of a window in a building or in land vehicle, marine vehicle or air vehicle or as an installation part in furniture and apparatus.

### BRIEF DESCRIPTION OF THE DRAWINGS

The invention is hereinafter explained in more detail by way of drawings and an example. The drawings are not completely true to scale. The invention is in no way limited by the drawings. There are shown in:

FIG. 1: a schematic cross-sectional representation of a fire-protection pane according to the invention,

FIG. 2A: a schematic cross-sectional representation of a fire-protection glazing according to the invention,

FIG. 2B: a schematic cross-sectional representation of an alternative embodiment of a fire-protection glazing according to the invention,

FIG. 3: a schematic cross-sectional representation of an alternative embodiment of a fire-protection glazing according to the invention,

FIG. 4A: a schematic cross-sectional representation of an alternative embodiment of a fire-protection glazing according to the invention,

FIG. 4B: a schematic cross sectional representation of an alternative embodiment of a fire-protection glazing according to the invention,

FIG. 5: a flow diagram of one embodiment example of the method according to the invention and

FIG. 6: a diagram of the hazing of fire-protection panes with different protective layers.

### DETAILED DESCRIPTION OF THE INVENTION

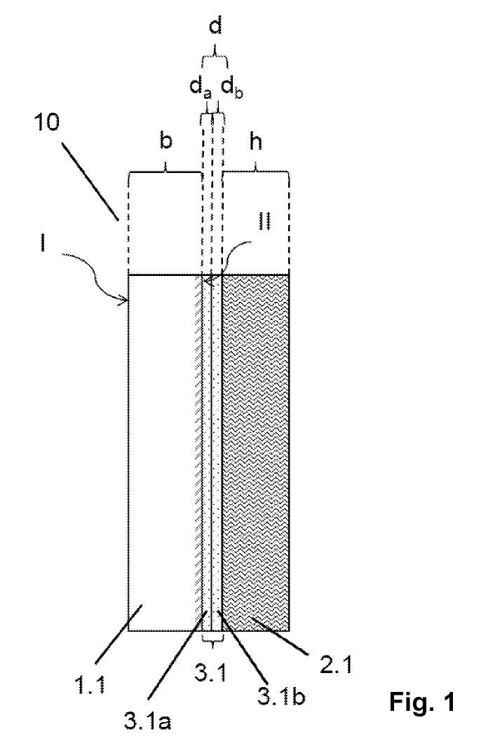

FIG. 1 shows a schematic representation of a fire-protection pane 10 according to the invention, in cross section. The fire-protection pane 10 includes a float glass pane 1.1 with an atmosphere side I and with a tin bath side II. The float glass pane 1.1, for example, has a thickness b of 5 mm and dimensions of 2 m×3 m. It is to be understood that the float glass pane 1.1 can also have other thicknesses and dimensions adapted to the respective application purpose.

A protective layer 3.1 is arranged on the tin bath side II of the float glass pane 1.1. A fire-protection layer 3.1 of an alkaline polysilicate is arranged on the protective layer 3.1. The protective layer 3.1 extends partly and preferably essentially over the entire tin bath side II of the float glass pane 1.1. The protective layer 3.1 in particular extends over the complete surface between the fire-protection layer 2.1 and the float glass pane 1.1. By way of this, it is ensured that the surface of the tin bath side II of the float glass pane 1.1 is protected from the alkaline polysilicate of the fire-protection layer 2.1.

The protective layer 3.1 is designed as a two-layer layer structure of a first sub-protective-layer 3.1a and of a second sub-protective-layer 3.1b.

The first sub-protective-layer 3.1a, for example, consists of an aluminium-doped silicon nitride layer and was deposited by way of cathode spluttering. The deposition was effected from a target of aluminium-doped silicon amid the addition of nitrogen as a reaction gas during the cathode spluttering. The aluminium-doped silicon nitride layer, for example, has a share of the doping metal of 5% by weight and a thickness dₐ of 8 nm, for example.

The second sub-protective-layer 3.1b of antimony-doped tin/zinc oxide was deposited by way of cathode spluttering. The target for deposition of the second sub-protective-layer 3.1b contained 68% by weight of zinc, 30% by weight of tin and 2% by weight of antimony. The deposition was effected amid the addition of oxygen as a reaction gas during the cathode spluttering. The second sub-protective-layer 3.1b has a thickness d_{b}, for example, of 15 nm. The thickness d of the complete protective layer 3.1 is thus 23 nm.

As trials of the inventor have shown, an advantageously increased ageing resistance and a greatly reduced hazing as well as an increased durability in the corrosion test and in the scratch test could be achieved already with a sub-protective-layer 3.1a of aluminium-doped silicon nitride, which had a thickness dₐ of 3 nm.

In this design example, the sub-protective-layer 3.1a of aluminium-doped silicon nitride is arranged directly on the tin bath side II of the float glass pane 1.1, and the second sub-protective-layer 3.1b of antimony-doped tin/zinc oxide is arranged on the first sub-protective-layer 3.1a of aluminium-doped silicon nitride. It is to be understood that the sequence of materials can also be exchanged, so that a layer of antimony-doped tin/zinc oxide is arranged directly on the tin bath side of the float glass pane, and a layer of aluminium-doped silicon nitride is arranged on the layer of antimony-doped tin/zinc oxide.

The fire-protection layer 2.1 for example includes a cured polysilicate, which is formed from an alkali silicate and at least one curing agent, for example of potassium silicate or colloidal silicic acid. In an alternative design, the potassium silicate can also be manufactured directly from potassium hydroxide solution and silicon dioxide. The molar ratio of silicon dioxide and potassium oxide (SiO₂:K₂O), for example, is 4.7:1. Such a fire-protection layer 2.1 is typically alkaline with a pH value of 12. The thickness h of the fire-protective layer 2.1 is 3 mm, for example.

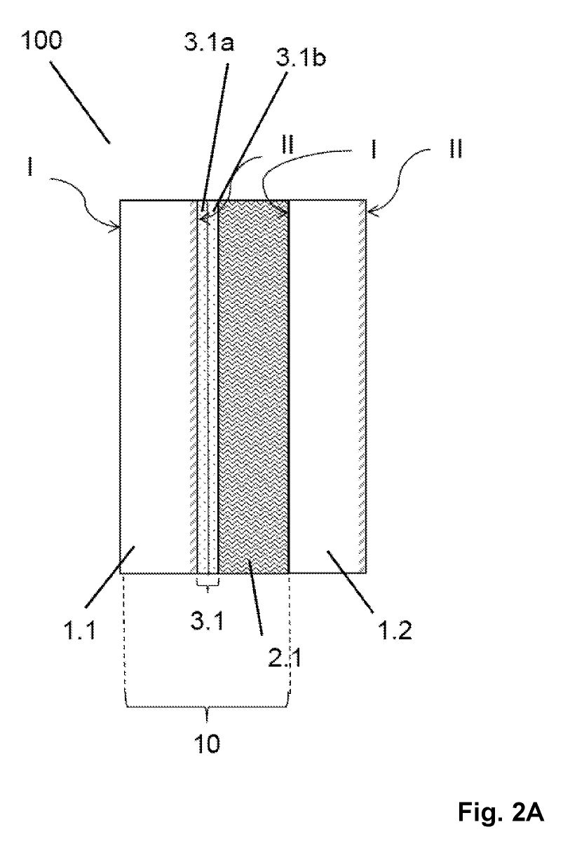

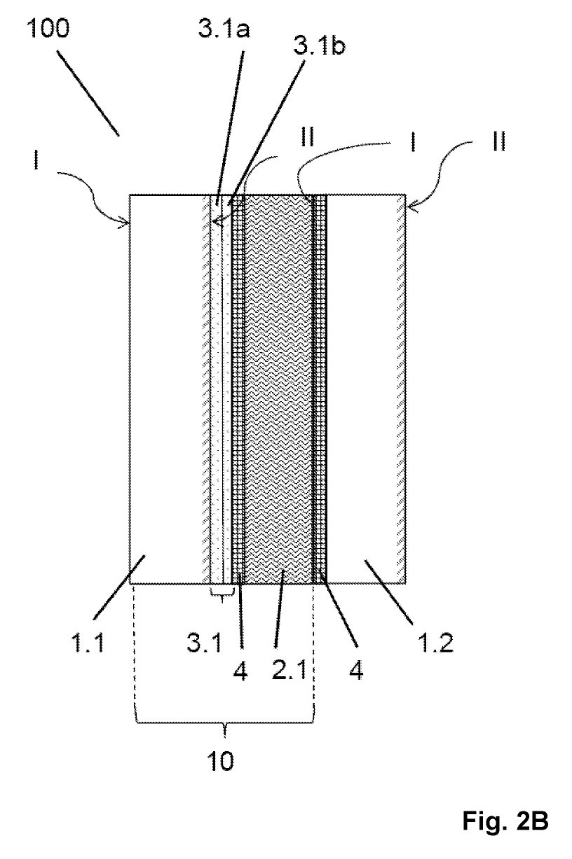

FIG. 2A shows a schematic cross-sectional representation of a fire-protection glazing 100 according to the invention. The fire-protection glazing 100 according to the invention, for example, includes a fire-protection pane 10 according to the invention, as is described in FIG. 1. Furthermore, the fire-protection layer 2.1 of the fire protection pane 10 is connected to the atmosphere side I of a second float glass pane 1.2 in a surfaced manner at the side of fire-protection layer, which is opposite to the protective layer 3.1. The second float glass pane 1.2 in its nature corresponds, for example, to the float glass pane 1.1.

FIG. 2B shows a schematic cross-sectional representation of an alternative example of a fire-protection glazing 100 according to the invention. The fire-protection glazing 100 according to the invention corresponds to that of FIG. 2A. A bonding reduction layer 4 is arranged between the protective layer 3.1 and the fire-protection layer 2.1 as well as between the fire-protection layer 2.1 and the second float glass pane 1.2, in order to improve the characteristics in the case of fire. The bonding reduction layer 4, for example, includes organofunctional silane with a hydrophobic effect. The bonding reduction layer 4 has the particular advantage that in the case of fire, with the fracturing of the float glass pane 1.1, 1.2, the individual fragments can detach from the fire-protection layer 3.1 without the coherency of the fire-protection layer 3.1 being lost.

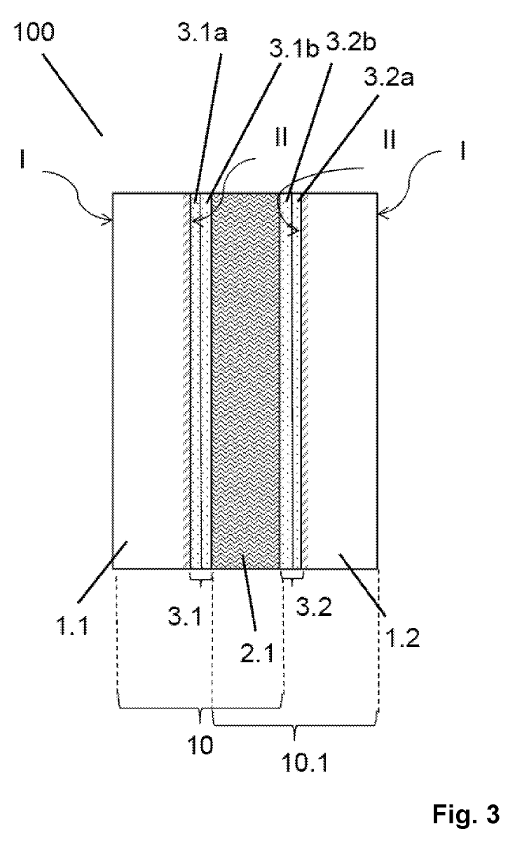

FIG. 3 shows a schematic cross-sectional representation of an alternative example of a fire-protection glazing 100 according to the invention. The fire-protection glazing 100 according to the invention, for example, includes a fire-protection pane 10 according to the invention, as is described in FIG. 1. The fire-protection layer 2.1 of the fire-protection pane 10 at the side that is opposite to the protective layer 3.1 is moreover connected via a second protective layer 3.2 to the tin bath side II of a second float glass pane 1.2. Again, the second float glass pane 1.2 and the second protective layer 3.2 with the fire-protection layer 2.1 form a fire-protection pane 10.1 according to the invention. According to the invention, a hazing of the view through the fire-protection glazing 100 is avoided on ageing since the tin bath side II of the float glass pane 1.1 as well as the tin bath side II of the second float glass pane 1.2 are separated from the fire-protection layer 2.1 by a protective layer 3.1, 3.2.

The first protective layer 3.1 as well as the second protective layer 3.2 consist of two-layer layer structures, wherein a first sub-protective-layer 3.1a, 3.2a, for example, contains aluminium-doped silicon nitride and is arranged directly on the tin bath side II of the float glass panes 1.1, 1.2 in each case, and a second sub-protective-layer 3.1b, 3.2b, for example, of antimony-doped tin/zinc oxide is arranged between the first sub-protective-layers 3.1a, 3.2a and the fire-protection layer 2.1.

Such a fire-protection glazing 100 is suitable for an independent application as a construction element in a building or as a vehicle glazing.

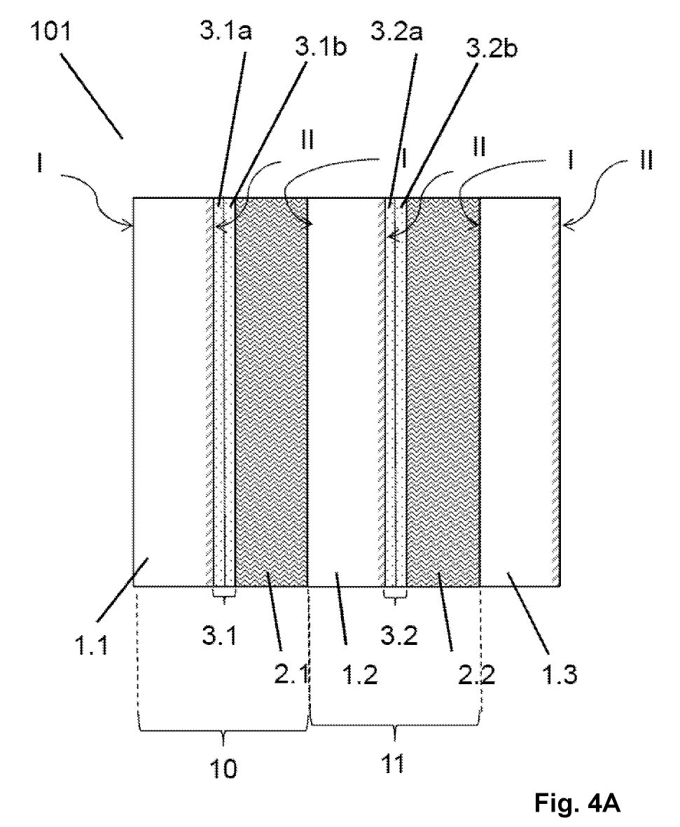

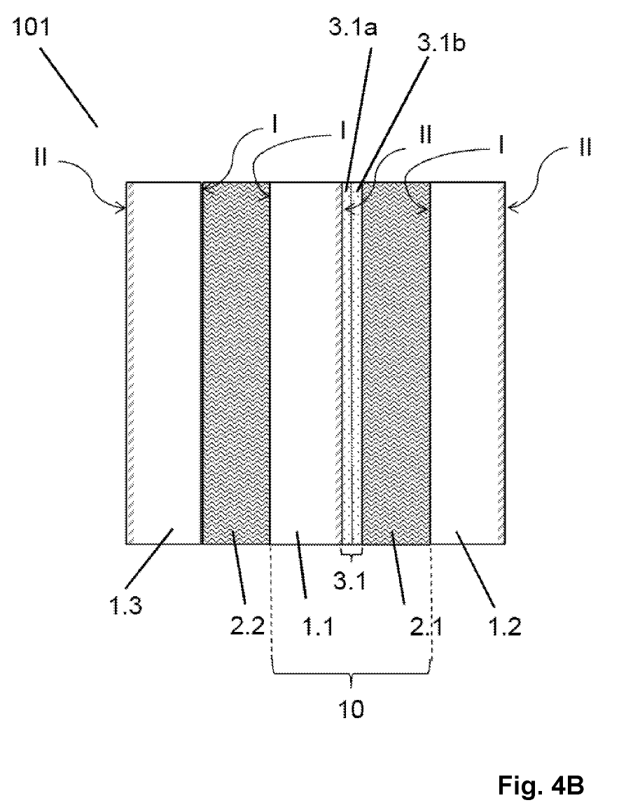

FIG. 4A shows a schematic cross-sectional representation of an alternative example of a fire-protection glazing 101 according to the invention, with the example of a triple glazing with three float glass panes 1.1, 1.2, 1.3 and two fire-protection layers 2.1, 2.2. The fire-protection glazing 101 according to the invention for example includes a fire-protection pane 10 according to the invention, as is described in FIG. 1, with a two-layer protective layer 3.1 of a first sub-protective-layer and a second sub-protective-layer. Moreover, the fire-protection layer 2.1 of the fire-protection pane 10 at the side that is opposite to the protective layer 3.1 is connected in a surfaced manner to the atmosphere side I of a second float glass pane 1.2. The second float glass pane 1.2 at its tin bath side II includes a second protective layer 3.2 and is connected via this to a second fire-protection layer 2.2. The second float glass pane 1.2, the protective layer 3.2 and the fire-protection layer 2.2 again form a fire-protection pane 11 according to the invention. The side of the second fire-protection layer 2.2, which is away from the second protective layer 3.2 is connected to the atmosphere side I of a third float glass pane 1.3.

FIG. 4B shows an alternative embodiment example of a fire-protection glazing 101 according to the invention. The fire-protection layer 2.1 of a fire-protection pane 10 according to the invention is connected in a surfaced manner to the atmosphere side I of a second float glass pane 1.2. The atmosphere side I of the float glass pane 1.1 is moreover connected in a surfaced manner to a second fire-protection layer 2.2. The second fire-protection layer 2.2 is connected in a surfaced manner to the atmosphere side I of a third float glass pane 1.3. This embodiment has the particular advantage that only one protective layer 3.1 according to the invention is required, in order to create a fire-protection glazing 101 that is resistant to ageing, since only the tin bath side II of the float glass pane 1.1 is arranged directly adjacently to the fire-protection layer 2.1 and without a separation by glass, due to a suitable arrangement of the outer-lying float glass panes 1.2, 1.3.

The triple glazing, which is represented in FIGS. 4A and 4B, displays a particularly high stability and fire-protection effect. It is to be understood that fire-protection panes with four or more float glass panes can also be manufactured according to a similar principle, wherein a protective layer according to the invention is arranged between each fire-protection layer and the directly adjacently arranged tin bath side of a float glass pane, for the inventive avoidance of hazing of the through-view on ageing.

The fire-protection pane 10, 11 and the fire-protection glazing 100, 101 of the embodiments represented here can include further spacers between the adjacent float glass panes 1.1, 1.2, 1.3 and edge sealing around the fire-protection layers 2.1, 2.2, the spacers being known per se and not being represented here. Suitable materials for the edge sealing, for example, contain polyisobutylene as spacers, and polysulphide, polyurethane or silicone as an edge sealing.

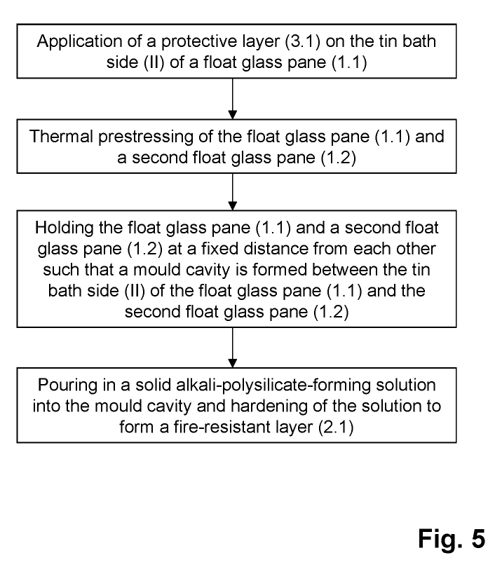

FIG. 5 shows a flow diagram of one embodiment of the method according to the invention, for manufacturing a fire-protection glazing 100 according to the invention and according to FIG. 2.

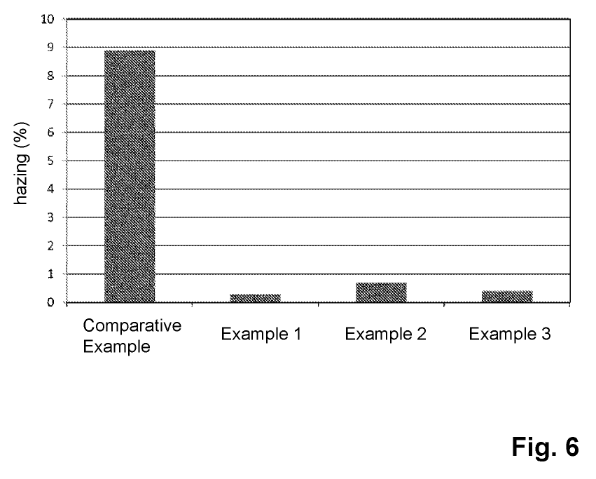

FIG. 6 shows a diagram of the hazing in an ageing test of fire-protection panes 10 with different protective layers of individual layers. The respective float glass pane in the accelerated ageing test was immersed in an aqueous solution of potassium silicate over a time period of 4 hours and at a temperature of 80° C. The aqueous potassium silicate solution is the alkaline component on manufacturing a fire-protection layer according to the invention from an alkali polysilicate hydrogel. The haze was measured with a haze measurement apparatus of the type “haze-gard plus” of the company BYK Gardner.

Example 1 is a float glass pane, whose tin bath side II was coated with a protective layer of a single tin/zinc oxide layer. Thereby, the ratio of tin to zinc was 50% by weight:50% by weight. The thickness d of the protective layer was 25 nm. A hazing of 0.3% was measured according to the ageing test.

Example 2 is a float glass pane, whose tin bath side II was coated with a protective layer of a single zinc oxide layer. The thickness d of the protective layer was 25 nm. A hazing of 0.7% was measured according to the ageing test.

Example 3 is a float glass pane, whose tin bath side II was coated with a protective layer of a single indium tin oxide (ITO) layer. Thereby, the ratio of indium to tin was 90% by weight:10% by weight. The thickness d of the protective layer was 25 nm. A hazing of 0.4% was measured according to the ageing test.

The comparative example was a float glass pane, with which neither the atmosphere side I nor the tin bath side II were coated, and thus both sides were exposed to the aqueous solution of potassium silicate. A haze of 8.9% was measured with the comparative example according to the ageing test.

With the represented ageing tests, the atmosphere sides I of the float glass panes of the Examples 1 to 3 and of the comparative example were not protected by a protective layer and thus were directly exposed to the aqueous solution of potassium silicate. From this, one can conclude that the hazing is effected essentially by the contact of the tin bath side II with the aqueous solution of potassium silicate.

Each of the protective layers of the Examples 1 to 3 reduces the hazing of the float glass pane to values <1%, in comparison to the comparative example without a protective layer. The haze was even reduced by 89-fold with the protective layer of a single tin/zinc oxide layer according to Example 1. This result was unexpected and surprising to the person skilled in the art.

Even better results can be achieved for the inventive fire-protection panes 10 with protective layers 3.1 with a two-layer or multi-layer layer structure.

The results of the ageing test and the haze test for different embodiment examples of fire-protection panes 10 according to the invention with comparative examples are represented in a conclusive manner in Table 1.

TABLE 1

| | pane or layer | | | |
|---|---|---|---|---|
| layer structure | thickness(es) | corrosion test | hazing test | scratch rest |
| float glass pane/ | 4 mm/ | good | good | many |
| Sb:tin/zinc oxide | 15 nm | | | |
| float glass pane/ | 4 mm/ | good | satisfactory | few |
| Al:silicon nitride | 8 nm | | | |
| float glass pane(1.1)/ | 4 mm(1.1)/ | satisfactory | good | few |
| Sb:tin/zinc oxide(3.1b)/ | 15 nm(3.1b)/ | | | |
| Al:silicon nitride (3.1a) | 8 nm(3.1a) | | | |
| float glass pane/ | 4 mm/ | good | very good | few |
| B:silicon nitride/ | 8 nm/ | | | |
| Sb:tin/zinc oxide | 15 nm | | | |
| float glass pane(1.1)/ | 4 mm(1.1)/ | very good | very good | almost none |
| Al:silicon nitride (3.1a)/ | 8 nm (3.1a)/ | | | |
| Sb:tin/zinc oxide (3.1b) | 15 nm (3.1b) | | | |

A fire-protection glazing was examined regarding the corrosion test, the scratch test and the haze test. A fire-protection pane 10 of a float glass pane 1.1 with a protective layer 3.1 on the tin bath side II and of an alkaline fire-protection layer 2.1 was connected to the atmosphere side I of a further float glass pane 1.2, for the manufacture of the fire-protection glazing.

The respective fire-protection glazing was stored over a time period of 14 days at a temperature of 80° C. in the corrosion test and in the scratch test. The fire-protection glazing in the corrosion test was subsequently visually examined with regard to strip-like hazing, wherein the strips are orientated in the production direction of the float glass pane. Such strip-like hazing is due to an interaction of the fire-protection layer with the tin bath side II of the float glass 1.1. “Very good” means that almost no strip-like hazing in the production direction is to be recognised and “satisfactory” means that comparatively much strip-like hazing is to be recognised.

The fire-protection glazing was moreover visually examined with regard to randomly oriented scratches in the scratch test. Such scratches, inherently of production, result on the tin bath side II of the float glass pane 1.1. “Very good” means that almost no randomly orientated scratches are to be recognised, and “satisfactory” means that comparatively many randomly orientated scratches are to be recognised.

The respective fire-protection glazing was stored over a period of 1 year at a temperature of 60° C. in the haze test. The haze was measured with a haze measurement apparatus of the type “haze-gard plus” of the company BYK Gardner and indicates the homogeneous hazing of the fire-protection glazing. “Very good” here means a very slight hazing and “satisfactory” a greater hazing.

The material of the protective layer is specified in the first column of Table 1, and its (layer) thickness in the second columns. The protective layers are each arranged directly adjacently to the tin bath side II of the float glass pane 1.1. The detail Al:silicon nitride (3.1a)/Sb:tin/zinc oxide (3.1b) describes a protective layer 3.1 according to the invention and for example specifies that the protective layer 3.1 consists of a two-layer layer structure. Thereby, the firstly mentioned first sub-protective-layer 3.1a of aluminium-doped silicon nitride is arranged directly on the float glass pane 1.1, and the second sub-protective-layer 3.1b of antimony-doped tin/zinc oxide is arranged between the first sub-protective-layer 3.1b and the fire-protection layer 2.1. The reverse sequence accordingly applies to the layer sequence Sb:tin/zinc oxide(3.1b)/Al:silicon nitride (3.1a) according to the invention.

The tendencies that are represented in the table can be understood within the framework of a surprising model: A single antimony-doped tin/zinc oxide layer acts as a protective layer of the tin bath side II of the float glass pane 1.1 and effectively protects this form alkaline attack of the fire-protection layer 2.1. This leads to good results in the corrosion test and only to a very low hazing in the haze test. A multitude of randomly orientated scratches, which in the scratch test compromise the appearance of the fire-protection glazing, occurs during the production due to the fact that the antimony-doped tin/zinc oxide is relatively soft.

A single, relatively hard aluminium-doped silicon nitride layer in the corrosion test likewise leads to good results and to less strip-like hazing. A single aluminium-doped silicon nitride layer however only has a satisfactory protective effect in the long-term haze test.

An inventive protective layer 3.1 of a second sub-protective-layer 3.1b of antinomy-doped tin/zinc oxide directly on the tin bath side II of the float glass pane 1.1 and of a first sub-protective-layer 3.1a of aluminium-doped silicon nitride between the second sub-protective-layer 3.1b and the fire-protection layer 2.1 displays good results in the haze test and in the scratch test, but only satisfactory results in the corrosion test.

A protective layer 3.1 of a first sub-protective-layer 3.1a of boron-doped silicon nitride directly on the tin bath side II of the float glass pane 1.1 and of a second sub-protective-layer 3.1b of antimony-doped tin/zinc oxide between a first sub-protective-layer 3.1a and the fire-protection layer 2.1 shows very good results in the haze test and less scratches in the scratch test. However, much strip-like hazing can be ascertained in the corrosion test.

Surprisingly, the best results are provided by way of inventive protective layers 3.1 of a first sub-protective-layer 3.1a of aluminium-doped silicon nitride directly on the tin bath side II of the float glass pane 1.1 and of a second sub-protective-layer 3.1b of antimony-doped tin/zinc oxide between a first sub-protective-layer 3.1a and a fire-protection layer 2.1. These protective layers 3.1 displayed the best results in all three tests.

Thereby, what is particularly noticeable is the fact that a first sub-protective-layer 3.1a according to the invention and of aluminium-doped silicon nitride in combination with the second sub-protective-layer 3.1 of antimony-doped tin/zinc oxide displayed significantly improved results in the corrosion test as well as in the scratch test, compared to a first sub-protective-layer of boron-doped silicon nitride. This can be explained by the greater hardness of metal-doped silicon nitride layers 3.1a and here in particular of aluminium-doped silicon nitride layers 3.1a in comparison to non-metal-doped silicon nitride layers and here in particular to boron-doped silicon nitride layers. The harder metal-doped silicon nitride layers 3.1a in combination with the second sub-protective-layers 3.1b of antimony-doped tin/zinc oxide displayed the best results in all three tests.

This result was unexpected and surprising for the man skilled in the art.

### LIST OF REFERENCE NUMERALS

1, 1.1, 1.2, 1.3 float glass pane
2.1, 2.2 fire-protection layer
3.1, 3.2, 3.3 protective layer
3.1, 3.2a first sub-protective-layer
3.1b, 3.2b second sub-protective-layer
4 adhesion reduction layer
10, 10.1, 11 fire-protection pane
100, 101 fire-protection glazing
I atmosphere side of a float glass pane
II tin bath side of a float glass pane
b thickness of a float glass pane
d, dₐ, d_{b} thickness of a protective layer
h thickness of a fire-protection layer

1. A fire-protection pane, comprising
at least one float glass pane with an atmosphere side and with a tin bath side,
at least one protective layer that is arranged in a surfaced manner on the atmosphere side and/or the tin bath side and
at least one fire-protection layer, that is arranged in a surfaced manner on the protective layer,
wherein the protective layer is a multi-layer layer structure and comprises or contains a first sub-protective-layer of metal-doped silicon nitride, and a second sub-protective-layer of a tin/zinc oxide or a doped tin/zinc oxide.

2. The fire-protection pane according to claim 1, wherein the protective layer is a two-layer layer structure.

3. The fire-protection pane according to claim 1, wherein the first sub-protective-layer is arranged directly on the float glass pane, and the second sub-protective-layer is arranged between the first sub-protective-layer and the fire-protection layer.

4. The fire-protection pane according to claim 1, wherein the protective layer is arranged in a surfaced manner only on the tin bath side of the float glass pane.

5. The fire-protection pane according to claim 1, wherein the fire-protection layer is alkaline.

6. The fire-protection pane according to claim 1, wherein the fire-protection layer comprises alkali silicate, alkali silicate water glass, alkali phosphate, alkali tungstenate, alkali molybdate and/or mixtures or layer compositions thereof, preferably alkali polysilicate, alkali polyphosphate, alkali polytungstenate, alkali polymolybdate and/or mixtures or layer compositions thereof, and wherein the alkali element is preferably sodium, potassium, lithium and/or mixtures thereof, or the fire-protection layer comprises a hydrogel of crosslinked monomers and/or polymers, preferably polyacrylamide, poly-N-methyl acrylamide or polymerised 2-hydroxy-3-methacryloxypropyl trimethyl ammonium chloride.

7. The fire-protection pane according to claim 1, wherein the share of the doping metal of the first sub-protective-layer is 1% by weight to 20% by weight, and preferably from 3% by weight to 7% by weight and/or the doping metal of the first sub-protective-layer is aluminum.

8. The fire-protection pane according to claim 1, wherein the first sub-protective-layer has a thickness da of 5 nm to 50 nm and preferably of 8 nm to 13 nm.

9. The fire-protection pane according to claim 1, wherein in the second sub-protective-layer, the ratio of zinc:tin is 5% by weight:95% by weight to 95% by weight:5% by weight and preferably from 15% by weight:85% by weight to 70% by weight:30% by weight.

10. The fire-protection pane according to claim 1, wherein the second sub-protective-layer comprises at least one doping element, preferably antimony, fluorine, boron, silver, ruthenium, palladium, aluminum and tantalum, and the share of the doping element of the second sub-protective-layer is from 0.1% by weight to 5% by weight and preferably from 0.5% by weight to 2.5% by weight.

11. The fire-protection pane according to claim 1, wherein the second sub-protective-layer has a thickness db of 10 nm to 50 nm and preferably from 13 nm to 21 nm.

12. The fire-protection pane according to claim 1, wherein the float glass pane comprises borosilicate glass, alumosilicate glass, alkaline earth silicate glass or soda lime glass and preferably soda lime glass according to EN 572-1:2004 and/or the float glass pane is thermally prestressed or part-prestressed, and/or the float glass pane has a thickness b of 1 mm to 25 mm and preferably of 2 mm to 12 mm and/or the fire-protection layer has a thickness h of 0.5 mm to 70 mm.

13. A fire-protection glazing, comprising:
a fire-protection pane according to claim 1 and
a float glass pane with an atmosphere side and with a tin bath side,
wherein
the atmosphere side or
the tin bath side via a protective layer
is connected in a surfaced manner to the fire-protection layer of the fire-protection pane.

14. The fire-protection glazing according to claim 13, wherein the atmosphere side of the float glass pane of the fire-protection pane is connected in a surfaced manner to a fire-protection layer, and the fire-protection layer is connected in a surfaced manner to the atmosphere side or via a further protective layer to the tin bath side of a third float glass pane.

15. The fire-protection glazing according to claim 13, wherein the float glass pane or the float glass pane is connected in a surfaced manner to at least one stack sequence of a further fire-protection layer and of a further float glass pane, wherein a further protective layer according to the invention is arranged between each tin bath side and a directly adjacently arranged fire-protection layer.

16. A method for manufacturing a fire-protection glazing, wherein at least
a. one protective layer is deposited on the tin bath side of a float glass pane,
b. the float glass pane and a second float glass pane are thermally prestressed or part-prestressed,
c. the float glass pane and the second float glass pane are held at a fixed distance, so that a mould cavity is formed between the tin bath side of the float glass pane and the second float glass pane and
d. a fire-protection layer is cast into the mould cavity and cured.

17. The method according to claim 16, wherein the method steps are repeated at least once with a further float glass pane and with a further fire-protection layer.

18. Use of a protective layer between a tin bath side of a float glass pane and a fire-protection layer according to claim 1, for reducing the hazing of a float glass pane on ageing.
